(19) United States
(12) Patent Application Publication
(10) Pub. No.: US 2016/0134429 A1
(43) Pub. Date: May 12, 2016

(54) NON-TRANSITORY COMPUTER READABLE MEDIUM, INFORMATION PROCESSING APPARATUS, AND QUESTIONNAIRE PROCESSING METHOD

(71) Applicant: FUJI XEROX CO., LTD, Tokyo (JP)

(72) Inventor: Yuhei SHIMADA, Kanagawa (JP)

(21) Appl. No.: 14/716,328

(22) Filed: May 19, 2015

(30) Foreign Application Priority Data
Nov. 12, 2014 (JP) 2014-229866

(51) Int. Cl. H04L 12/18; G06F 3/0484

(52) U.S. Cl. CPC H04L 12/1822; G06F 3/0484

(57) ABSTRACT

A non-transitory computer readable medium stores a program causing a computer to execute a process for processing a questionnaire. The process includes distributing a question at a distribution time to multiple information terminals of multiple users, the distribution time being associated with a time when an event occurs, the question being associated with the event, the users being involved in the event; accepting multiple responses to the distributed question, from the information terminals; and tabulating the responses on the basis of time differences. Each of the time differences is a difference between the distribution time and a time when a corresponding one of the responses is accepted.

### CROSS-REFERENCE TO RELATED APPLICATIONS

This application is based on and claims priority under 35 USC 119 from Japanese Patent Application No. 2014-229866 filed Nov. 12, 2014.

### BACKGROUND

### Technical Field

The present invention relates to a non-transitory computer readable medium, an information processing apparatus, and a questionnaire processing method.

### SUMMARY

According to an aspect of the invention, there is provided a non-transitory computer readable medium storing a program causing a computer to execute a process for processing a questionnaire. The process includes distributing a question at a distribution time to multiple information terminals of multiple users, the distribution time being associated with a time when an event occurs, the question being associated with the event, the users being involved in the event; accepting multiple responses to the distributed question, from the information terminals; and tabulating the responses on the basis of time differences. Each the time differences is a difference between the distribution time and a time when a corresponding one of the responses is accepted.

### BRIEF DESCRIPTION OF THE DRAWINGS

Exemplary embodiments of the present invention will be described in detail based on the following figures, wherein:

FIG. 1 is a schematic view illustrating an exemplary configuration of an information processing system according to an exemplary embodiment;

FIG. 2 is a block diagram illustrating an exemplary configuration of an information processing apparatus according to the exemplary embodiment;

FIG. 3 is a schematic view illustrating an exemplary configuration of question information;

FIG. 4 is a schematic view illustrating an exemplary configuration of position information;

FIG. 5 is a schematic view illustrating an exemplary configuration of distribution information;

FIG. 6 is a schematic view illustrating an exemplary configuration of response information;

FIGS. 7A to 7C are views for illustrating a distributing operation;

FIGS. 8A and 8B are views for illustrating a tabulating operation;

FIG. 9 is a schematic view for illustrating another exemplary tabulating operation;

FIG. 10 is a schematic view for illustrating another exemplary tabulating operation;

FIG. 11 is a schematic view for illustrating another exemplary tabulating operation; and

FIGS. 12A to 12C are schematic views for illustrating another exemplary tabulating operation.

### DETAILED DESCRIPTION

### Exemplary Embodiment

Configuration of information processing system

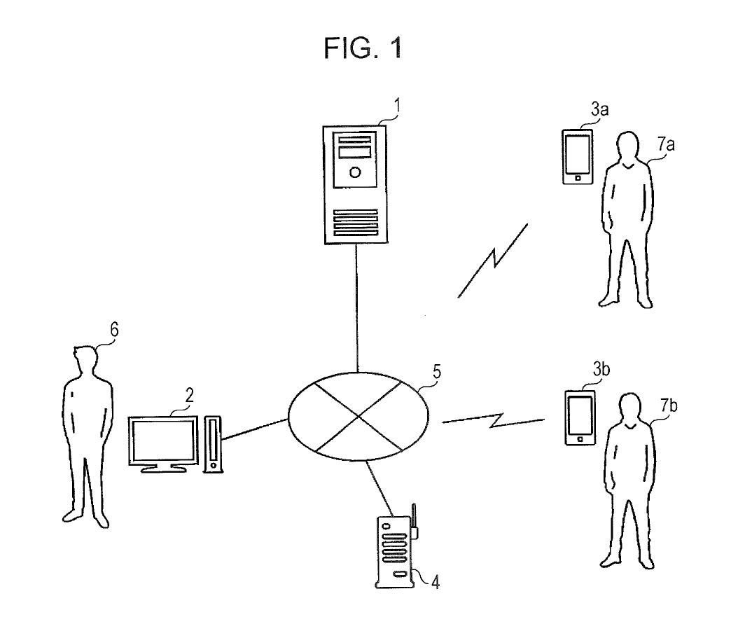

FIG. 1 is a schematic view illustrating an exemplary configuration of an information processing system according to an exemplary embodiment.

The information processing system has a configuration in which an information processing apparatus 1, an information terminal 2, information terminals 3a and 3b, and a position-information acquiring apparatus 4 are connected to one another via a network 5 so as to be capable of communicating with one another. The information terminal 2 is operated by an analyst 6 who carries out and analyzes a questionnaire, and the information terminals 3a and 3b are operated by respondents 7a and 7b, respectively, who answer a question in the questionnaire.

The information processing apparatus 1 distributes a question in an questionnaire to the information terminals 3a and 3b, and receives and tabulates responses to the question in the questionnaire. The information processing apparatus 1 operates in response to a request from the information terminal 2, and includes electronic components, such as a central processing unit (CPU) having functions for processing information and a flash memory, in the main body thereof.

The information terminal 2 is an information processing apparatus such as a personal computer (PC) which transmits a request to the information processing apparatus 1 in response to an operation performed by the analyst 6 and which, for example, receives and displays a response to the request. The information terminal 2 includes electronic components, such as a CPU having functions for processing information and a flash memory, in the main body thereof. The information terminal 2 is not limited to a PC, and may be a tablet terminal, a smartphone, or the like.

The information terminals 3a and 3b are information processing apparatuses such as smartphones which receive and display a question in a questionnaire distributed from the information processing apparatus 1, which answer the question in the questionnaire in accordance with operations performed by the respondents 7a and 7b, and which transmit the answers to the information processing apparatus 1. The information terminals 3a and 3b include electronic components, such as a CPU having functions for processing information and a flash memory, in the main body thereof. The information terminals 3a and 3b are not limited to smartphones, and may be tablet terminals, wearable devices, PCs, or the like.

The position-information acquiring apparatus 4 obtains position information of the information terminals 3a and 3b. For example, as the position-information acquiring apparatus 4, an apparatus which obtains position information from the radio frequency identifications (RFIDs) included in the information terminals 3a and 3b, an apparatus which obtains position information by communicating with the information terminals 3a and 3b through Bluetooth® or wireless fidelity (Wifi), a global positioning system (GPS), or the like may be used.

The network 5 is a communication network through which data communication is capable of being performed, and is a wired or wireless communication network, such as the Internet or a local area network (LAN).

In the above-described configuration, the information processing apparatus 1, for example, obtains position information of the information terminals 3a and 3b from the position-information acquiring apparatus 4, transmits a question in a questionnaire to the information terminals 3a and 3b in accordance with the positions of the information terminals 3a and 3b, receives responses from the information terminals 3a and 3b when the respondents 7a and 7b answer the question in the questionnaire, and tabulates the received responses and transmits the tabulation result to the information terminal 2. The information terminal 2 displays the tabulation result of the received responses so as to present the result to the analyst 6.

### Configuration of Information Processing Apparatus

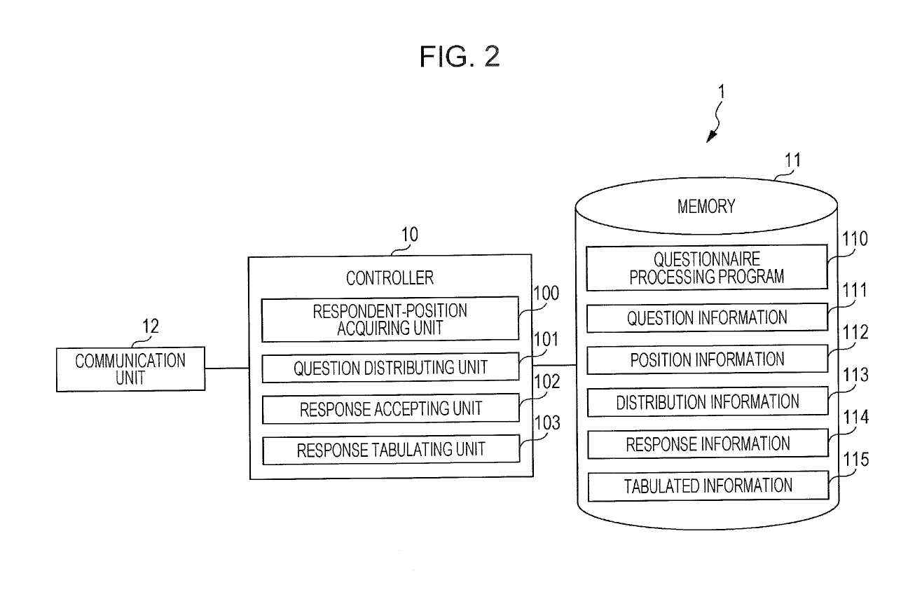

FIG. 2 is a block diagram illustrating an exemplary configuration of the information processing apparatus 1 according to the exemplary embodiment.

The information processing apparatus 1 includes a controller 10 which includes a CPU so as to control units and so as to execute various programs, a memory 11 which includes a storage medium such as a flash memory so as to store information, and a communication unit 12 which communicates with the outside via a network.

The controller 10 executes a questionnaire processing program 110 described below, thereby functioning as a respondent-position acquiring unit 100, a question distributing unit 101, a response accepting unit 102, a response tabulating unit 103, and the like.

The respondent-position acquiring unit 100 obtains position information of the information terminals 3a and 3b (respondents 7a and 7b) from the position-information acquiring apparatus 4 via the communication unit 12, and stores the position information as position information 112 in the memory 11.

When the position information 112 satisfies a condition defined in question information 111, the question distributing unit 101 transmits a question to the information terminals 3a and 3b (respondents 7a and 7b). The question distributing unit 101 stores information, such as time information indicating when the question was distributed, time information indicating when the response was received, the identifier of the question, and the identifier of the respondent, as distribution information 113 in the memory 11.

The response accepting unit 102 receives responses transmitted from the information terminals 3a and 3b, and stores the responses as response information 114 in the memory 11.

The response tabulating unit 103 tabulates the response information 114 by using the distribution information 113, and stores the result as tabulated information 115 in the memory 11. A specific tabulating method will be described below.

The memory 11 stores the questionnaire processing program 110 which causes the controller 10 to function as the units 100 to 103 described above, the question information 111, the position information 112, the distribution information 113, the response information 114, the tabulated information 115, and the like.

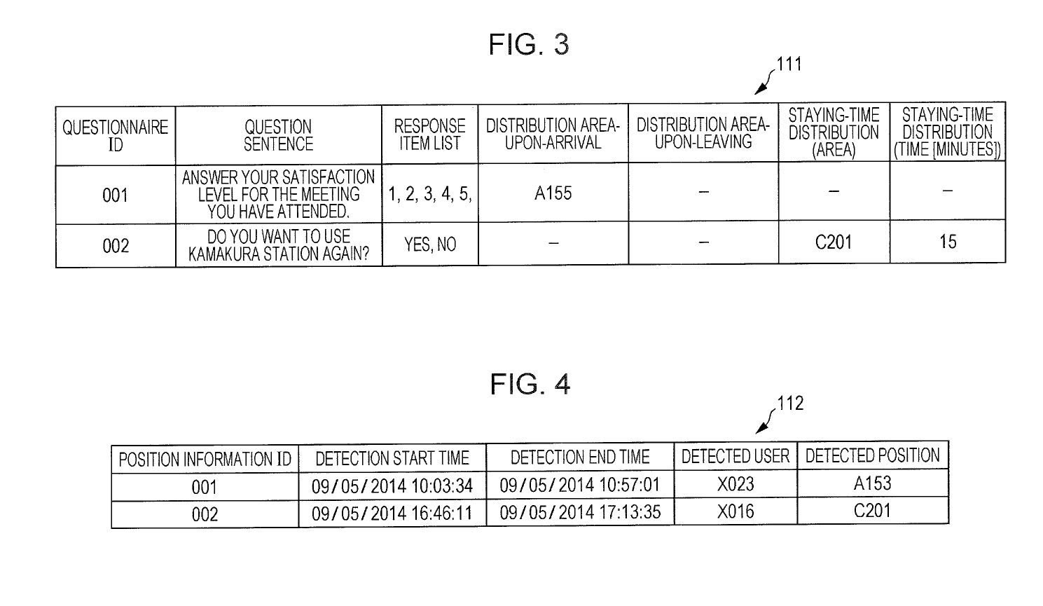

FIG. 3 is a schematic view illustrating an exemplary configuration of the question information 111.

The question information 111 includes a questionnaire ID for identifying the question in a questionnaire, a question sentence describing the question, a response item list indicating content of responses, and a distribution area-upon-arrival, a distribution area-upon-leaving, a staying-time distribution (area), and a staying-time distribution (time [minutes]) which indicate a condition for distributing the question. The question sentence indicates a question to be distributed to the information terminal of a respondent.

The distribution area-upon-arrival serves as a condition for distributing a question when an event in which a respondent arrives at the described area occurs. The distribution area-upon-leaving serves as a condition for distributing a question when an event in which a respondent leaves the described area occurs. The staying-time distribution (area) and the staying-time distribution (time [minutes]) serve as a condition for distributing a question when an event in which a respondent has stayed in the described area for the described staying time or more occurs. In short, in the examples illustrated in FIG. 3, a time to perform distribution is a time associated with an event occurrence. That is, the question in the questionnaire for the questionnaire ID “002” is distributed at a time when a respondent has stayed in the area C201 for 15 minutes.

FIG. 4 is a schematic view illustrating an exemplary configuration of the position information 112.

The position information 112 includes a position information ID for identifying the position information of a respondent, a detection start time when position detection was started, a detection end time when the position detection was ended, a detected user indicating the detected respondent, and a detected position indicating the detected position. In the detected position field, the identifier attached to an area may be described, or a single position coordinate set or multiple position coordinate sets may be described.

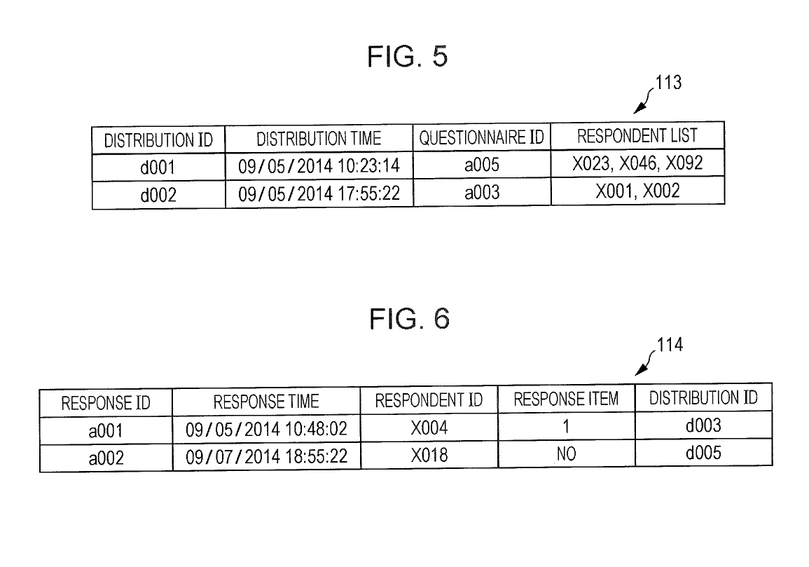

FIG. 5 is a schematic view illustrating an exemplary configuration of the distribution information 113.

The distribution information 113 includes a distribution ID for identifying distributed information, a distribution time indicating a time when the question was distributed, a questionnaire ID for identifying the distributed question, and a respondent list for identifying respondents to whom the question was distributed. The distribution information 113 is generated after a questionnaire is distributed.

FIG. 6 is a schematic view illustrating an exemplary configuration of the response information 114.

The response information 114 includes a response ID for identifying response information, a response time indicating a time when the response was received, a respondent ID for identifying the respondent, a response item indicating the content of the response, and a distribution ID for identifying distributed information corresponding to the question to which the response was made.

### Operations of Information Processing Apparatus

The operations according to the present exemplary embodiment will be described by classifying the operations into (1) a basic operation, (2) a distributing operation, and (3) a tabulating operation.

### (1) Basic Operation

The respondents 7a and 7b illustrated in FIG. 1, who are, for example, company staff and carry the information terminals 3a and 3b, each go to a meeting room to attend a meeting or the like. In this example, the action “attend a meeting” of a respondent is an exemplary event. Occurrence of the event causes distribution of a questionnaire described below. Other examples of an event include walking one kilometer or more, purchasing a specific product at a store, and viewing a movie for a predetermined time or more. An example in which, in order to detect occurrence of an event, the position information of a respondent is obtained will be described below. An exemplary embodiment is not limited to this, and schedule information, point-of-sale (POS) data, a speech detection log obtained by using a microphone, or the like may be used to detect occurrence of an event.

FIG. 1 illustrates one position-information acquiring apparatus 4, but multiple position-information acquiring apparatuses 4 may be prepared. For example, a position-information acquiring apparatus 4 is installed in each meeting room. When the information terminal 3a or 3b comes within a predetermined distance, the position-information acquiring apparatus 4 transmits the position information to the information processing apparatus 1 via the network 5. The position-information acquiring apparatus 4 regularly transmits the position information, e.g., transmits the position information every three minutes.

The information processing apparatus 1 obtains the position information of the information terminals 3a and 3b from the position-information acquiring apparatus 4. The respondent-position acquiring unit 100 of the information processing apparatus 1 obtains the position information of the information terminals 3a and 3b (respondents 7a and 7b) from the position-information acquiring apparatus 4 via the communication unit 12, and stores the position information as the position information 112 in the memory 11.

### (2) Distributing Operation

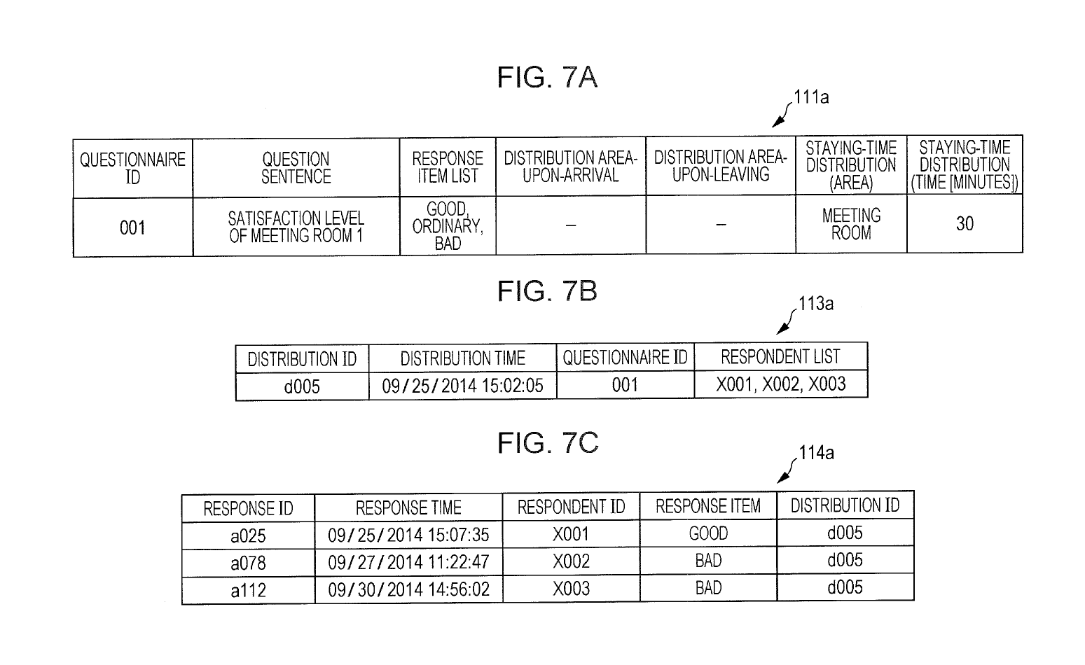

When the position information 112 or a time change in the position information 112 satisfies a condition defined in the question information 111, the question distributing unit 101 of the information processing apparatus 1 determines that an event occurs, and transmits the question to the information terminals 3a and 3b (respondents 7a and 7b). Description will be made by using the example in FIGS. 7A to 7C.

FIGS. 7A to 7C are diagrams for illustrating a distributing operation.

When question information 111a illustrated in FIG. 7A is prepared, the distribution condition of the question for the questionnaire ID “001” is a condition in which the staying-time distribution (area) is set to “meeting room” and in which the staying-time distribution (time [minutes]) is set to “30”. Therefore, when a person has stayed in a “meeting room” for “30” minutes, the question is distributed.

When the respondents 7a and 7b have stayed in a “meeting room” for “30” minutes or more, the question distributing unit 101 determines that an event of “attend a meeting” occurs, and transmits the question for the questionnaire ID “001” to the information terminals 3a and 3b (respondents 7a and 7b).

The question distributing unit 101 stores time information indicating when the question was distributed, the identifiers of the respondents, and the identifier of the question as the distribution information 113 in the memory 11. In the above-described example, distribution information 113a is generated as illustrated in FIG. 7B. Information for the distribution ID “d005” shows that the question for the questionnaire ID “001” was distributed to respondents for IDs in a respondent list “X001, X002, X003” at a time “09/25/2014 15:02:5”. It is assumed that the respondent IDs of the respondents 7a and 7b are “X001” and “X002”, respectively. The ID of the other respondent (not illustrated) is “X003”.

The respondents 7a and 7b check the question distributed to the information terminals 3a and 3b, and input responses by operating the operation units of the information terminals 3a and 3b. When the input operation is completed, the responses are transmitted from the information terminals 3a and 3b to the information processing apparatus 1. Similarly, the respondent for the respondent ID “X003” inputs a response.

The response accepting unit 102 receives the responses transmitted from the information terminals 3a and 3b, and stores the responses as the response information 114 in the memory 11. In the above-described example, as illustrated in FIG. 7C, the responses are stored as response information 114a. For example, information for the response ID “a025” shows that the respondent for the respondent ID “X001” responded to the question for the distribution ID “d005” with a response item “good” at the time “09/25/2014 15:07:35”. Information for the response ID “a078” shows that the respondent for the respondent ID “X002” responded to the question for the distribution ID “d005” with a response item “bad” at the time “09/27/2014 11:22:47”. Thus, even when the distribution time is the same, the response times are different from each other depending on the respondents. When times when events occur are different from each other, the distribution times may be different from each other depending on the respondents.

### (3) Tabulating Operation

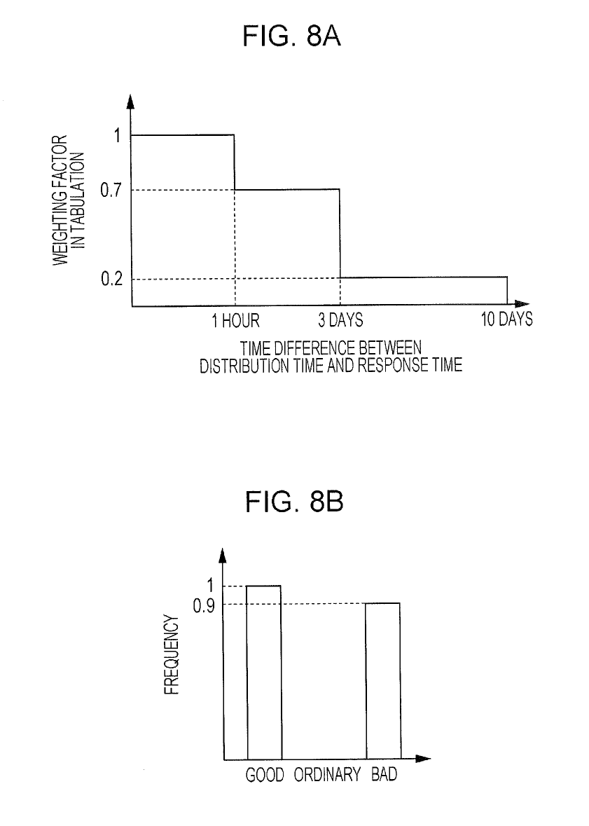

The response tabulating unit 103 uses the distribution information 113 to tabulate the response information 114, and stores the result as the tabulated information 115 in the memory 11. The response tabulating unit 103 tabulates the response information 114 by using weighting described below using FIGS. 8A and 8B, and uses the result as the tabulated information 115.

FIGS. 8A and 8B are views for illustrating a tabulating operation.

As illustrated in FIG. 8A, the response tabulating unit 103 weights response items on the basis of the time difference between an event occurrence time and a response time for the question for the event. An event occurrence time is associated with a distribution time. When it is determined that an event occurs, the question is distributed. Therefore, in the present exemplary embodiment, instead of an event occurrence time, a distribution time is used. For example, as illustrated in FIGS. 7B and 7C, the respondent for the respondent ID “X001” responded to the question for the distribution ID “d005” after elapse of 5 minutes 30 seconds from the distribution time. Accordingly, the weighting factor is set to “1”. The respondent for the respondent ID “X002” responded to the question for the distribution ID “d005” in after elapse of a time of one hour or more and three days or less from the distribution time. Accordingly, the weighting factor is set to “0.7”. The respondent for the respondent ID “X003” responded to the question for the distribution ID “d005” after elapse of three days or more from the distribution time. Accordingly, the weighting factor is set to “0.2”. That is, it is assumed that a larger time difference between a distribution time and a response time causes a memory or an impression of an event which is held by a respondent to become vaguer. Therefore, the weighting factor is made smaller. When a memory or an impression held by a respondent becomes vague, the respondent may be likely to give, for example, an evaluation of “3”, which is a safe response, in a five-grade evaluation system. In the case where the respondent feels uncomfortable even just a little and where the uncomfortable memory becomes a more uncomfortable memory over time, the respondent may give an evaluation of “1”. Such responses have reliability lower than that of responses transmitted just after the event occurs. If such responses are handled the same way, they are highly likely to function as noise. Therefore, to alleviate the adverse effect, the weighting factor is set as described above.

The information processing apparatus 1 has information (not illustrated) in which the time difference between a distribution time and a response time and a weighting factor, described above, are associated with each other, in a table form or the like, for example, in the memory 11.

The weighting illustrated in FIG. 8A is exemplary. For example, in consideration of handling a memory or an impression of an event which is held by a respondent, the weighting may be linearly decreased or exponentially decreased, or may employ a forgetting curve. Thus, the weighting may be expressed by using any straight line or any curve. Alternatively, the weighting may be not only simply decreased over time but also increased for a while and decreased when a predetermined trigger occurs. Instead, the weighting may be repeatedly increased and decreased.

As described above, the response item for the respondent ID “X001” is “good”, and the response items for the respondent IDs “X002” and “X003” are “bad”. Therefore, as described in FIG. 8B, “good =1” and “bad =0.7+0.2=0.9” in the tabulated information 115. The response tabulating unit 103 may perform weighting also when cross tabulation is performed on multiple questions.

The information processing apparatus 1 transmits the tabulated information 115 which is a tabulation result of the response information 114, to the information terminal 2.

The information terminal 2 receives the tabulated information 115, and displays the tabulated information 115 on a display. The analyst 6 checks the displayed tabulated information 115.

In the exemplary embodiment described above, the weighting factor is changed on the basis of the difference between a distribution time and a response time, but may be changed on the basis of the difference between a time when an event occurs and a response time. In this case, it is assumed that a larger time difference between a time when an event occurs and a response time causes a memory or an impression of the event which is held by a respondent to become vaguer, and the weighting factor is made smaller.

### FIRST MODIFIED EXAMPLE

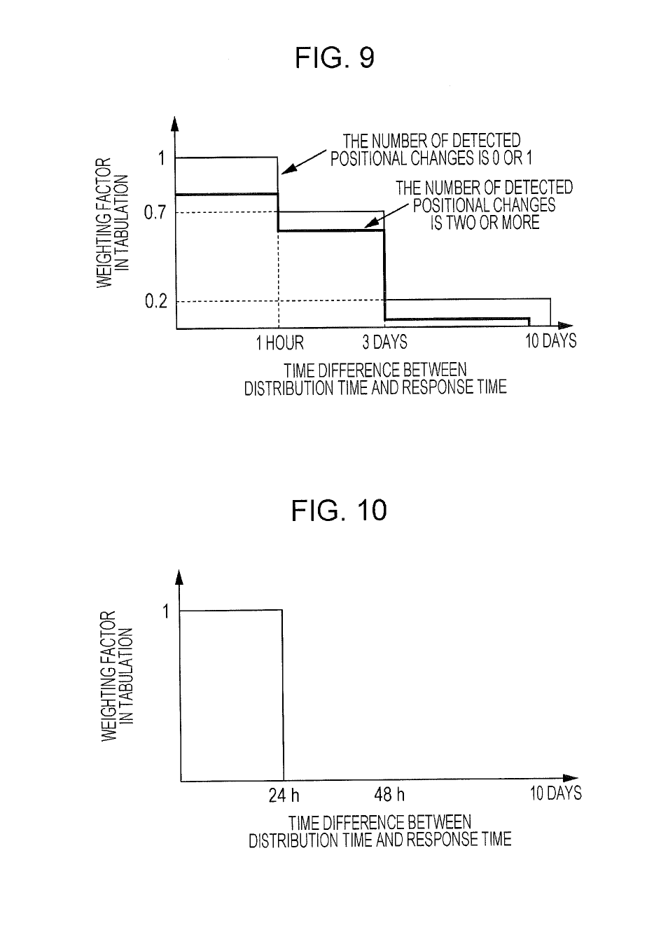

The response tabulating unit 103 may tabulate the response information 114 by using weighting described in FIG. 9 below. The response tabulating unit 103 performs weighting on a response item on the basis of the time difference between a distribution time and a response time. An action taken by a respondent from the distribution time to the response time may be taken into account. For example, even when the time differences between distribution times and response times are the same, e.g., one hour, evaluation of reliability of a response made at the same place without leaving the meeting room may be made different from evaluation of reliability of a response made after moving to a different place.

FIG. 9 is a schematic view for illustrating another exemplary tabulating operation.

As illustrated in FIG. 9, the response tabulating unit 103 assumes as follows. When the number of positional changes in which a respondent moves a predetermined distance or more from a distribution time to a response time is equal to zero or one, the weighting factor is made large (fine solid line). When the number of positional changes of the respondent is equal to two or more, the weighting factor is made small (bold solid line). This is a case in which it is assumed that a memory becomes vague while moving and that reliability of the response decreases. The magnitude of the weighting factor is exemplary, and the analyst 6 may set the weighting factor as appropriate. Instead of the number of positional changes, the weighting factor may be changed depending on whether or not the position is changed by a predetermined distance or more (for example, when the position is changed by a distance equal to or larger than 0 m and equal to or smaller than 10 m, the weighting factor is set to 1; when the position is changed by a distance larger than 10 m and equal to or smaller than 100 m, the weighting factor is set to 0.7; and when the position is changed by a distance larger than 100 m, the weighting factor is set to 0.2).

### SECOND MODIFIED EXAMPLE

The response tabulating unit 103 may tabulate the response information 114 by using weighting described in FIG. 10 below.

FIG. 10 is a schematic view for illustrating another exemplary tabulating operation.

The response tabulating unit 103 performs weighting on a response item on the basis of the time difference between a distribution time and a response time. It may be assumed that a memory of a routine event such as a regularly held meeting is easily lost, and, as illustrated in FIG. 10, only responses made within 24 hours from the distribution time may be used for tabulation.

### THIRD MODIFIED EXAMPLE

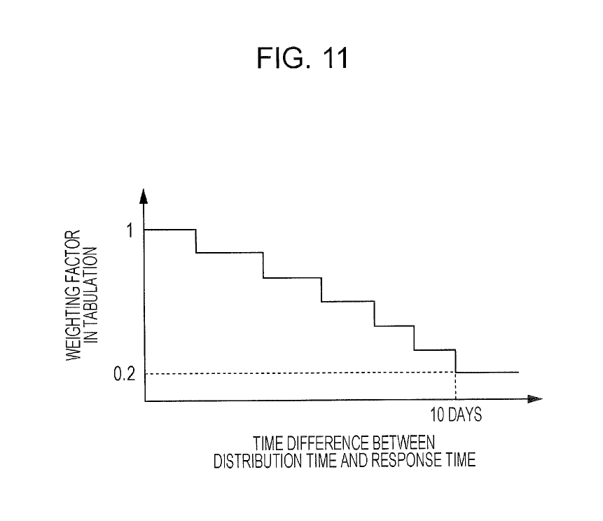

FIG. 11 is a schematic view for illustrating another exemplary tabulating operation.

The response tabulating unit 103 performs weighting on a response item on the basis of the time difference between a distribution time and a response time. It may be assumed that a big event held once in a year is easily memorable or impressive, and, as illustrated in FIG. 11, the weighting factor may be gradually decreased.

### FOURTH MODIFIED EXAMPLE

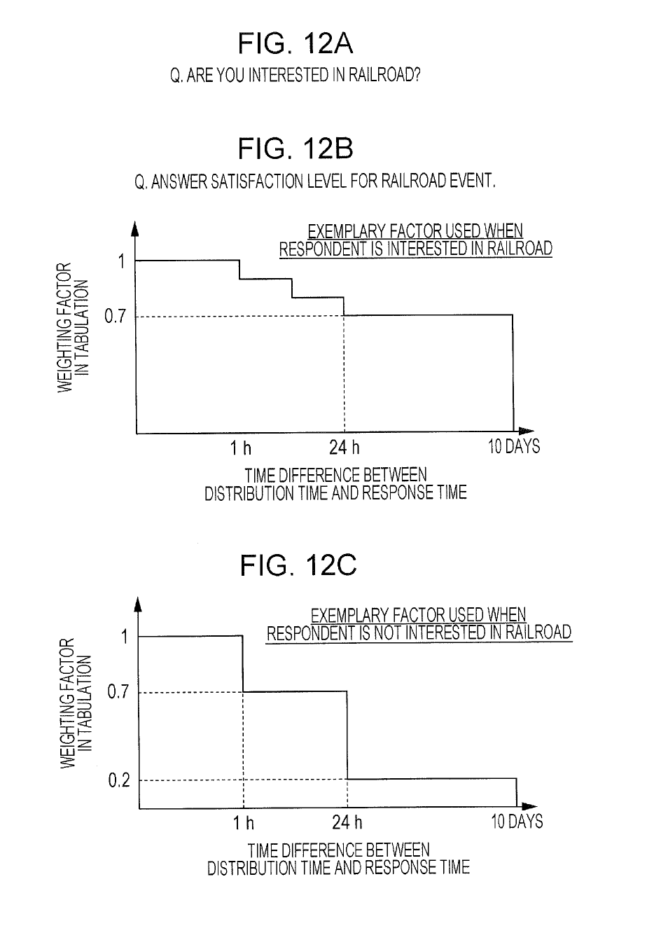

FIGS. 12A to 12C are schematic views for illustrating another exemplary tabulating operation.

The response tabulating unit 103 performs weighting on a response item on the basis of the time difference between a distribution time and a response time. It may be assumed that a memory of an interesting event easily remains and that a memory of an uninteresting event is easily lost, and, for example, a question for checking if a respondent shows an interest, as illustrated in FIG. 12A may be prepared, and the weighting factor for a response to the next question may be changed depending on the result of the response to the first question.

As illustrated in FIG. 12B, when the response indicates that the respondent shows an interest, the weighting factor for the response to the next question is gradually decreased. As illustrated in FIG. 12C, when the response indicates that the respondent shows no interest, the weighting factor for the response to the next question is sharply decreased compared with the case of FIG. 12B.

### Other Exemplary Embodiments

An exemplary embodiment of the present invention is not limited to the above-described exemplary embodiment. Various modifications may be made without departing from the gist of the present invention. For example, schedule information of a respondent may be used to change the weighting factor. When a response is made 60 minutes later than the distribution time, it may be assumed that the degree of vagueness of a respondent's memory which occurs in the case where the respondent attends another meeting before making the response is different from that which occurs in the case where the respondent deals with paperwork tasks, and, for example, the weighting factor for the latter case may be gradually decreased.

An attribute may be set to every question in a questionnaire, and the weighting factor may be changed in accordance with the attribute.

When a predetermined time has elapsed, no responses may be accepted from a respondent.

When a response is made in a form of free description, not by selecting an item, responses may be displayed to the analyst 6 in an order of the time difference between a distribution time and a response time. The free description may be segmented into parts of speech which are subjected to scoring, and the resulting value may be weighted.

When most of the values near the median of response times are close to a certain time, a time when the weighting starts being decreased may be changed in accordance with the median. Alternatively, timings of the subsequent distributions may be changed to the median, and the weighting may be normally decreased. The reason is as follows. Assume that most of the times until responses to a question distributed in accordance with occurrence of an event are made are close to 10 minutes after the event occurs. For example, the average time from a time when the respondents leave the meeting hall to a time when the respondents return back to their desks may be 10 minutes, and the respondents may respond at their desks. Accordingly, the question is distributed 10 minutes later than the event occurrence time, whereby the question may be distributed at the timing at which the respondents return back to their desks. Thus, the probability of obtaining more response results is increased. Instead, schedule information of the respondents may be used to change the respective distribution timings.

In the above-described exemplary embodiments, the functions of the units 100 to 103 of the controller 10 are implemented through a program. All or some of the units may be implemented through hardware such as an application-specific integrated circuit (ASIC). A program used in the above-described exemplary embodiments may be supplied by storing the program in a recording medium such as a compact disc-read-only memory (CD-ROM). Replacement, deletion, addition, or the like of the steps described in the above-described exemplary embodiments may be made without changing the gist of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process for processing a questionnaire, the process comprising:
distributing a question at a distribution time to a plurality of information terminals of a plurality of users, the distribution time being associated with a time when an event occurs, the question being associated with the event, the plurality of users being involved in the event;
accepting a plurality of responses to the distributed question, from the plurality of information terminals; and
tabulating the plurality of responses on a basis of time differences, each of the time differences being a difference between the distribution time and a time when a corresponding one of the plurality of responses is accepted.

2. The non-transitory computer readable medium according to claim 1,
wherein the tabulating tabulates the plurality of responses by multiplying a weighting factor by the number of responses among the plurality of responses, the responses among the plurality of responses corresponding to a time difference, the weighting factor corresponding to the time difference.

3. The non-transitory computer readable medium according to claim 2,
wherein the weighting factor is set in such a manner as to be smaller as the time difference gets larger.

4. The non-transitory computer readable medium according to claim 1, further comprising:
obtaining position information of the plurality of information terminals,
wherein, when the position information of the plurality of information terminals satisfies a predetermined condition, the distributing determines that the event occurs.

5. The non-transitory computer readable medium according to claim 2, further comprising:
obtaining position information of the plurality of information terminals,
wherein, when the position information of the plurality of information terminals satisfies a predetermined condition, the distributing determines that the event occurs.

6. The non-transitory computer readable medium according to claim 3, further comprising:
obtaining position information of the plurality of information terminals,
wherein, when the position information of the plurality of information terminals satisfies a predetermined condition, the distributing determines that the event occurs.

7. An information processing apparatus comprising:
a distribution unit that distributes a question at a distribution time to a plurality of information terminals of a plurality of users, the distribution time being associated with a time when an event occurs, the question being associated with the event, the plurality of users being involved in the event;
an accepting unit that accepts a plurality of responses to the distributed question, from the plurality of information terminals; and
a tabulating unit that tabulates the plurality of responses on a basis of time differences, each of the time differences being a difference between the distribution time and a time when a corresponding one of the plurality of responses is accepted.

8. A questionnaire processing method comprising:
distributing a question at a distribution time to a plurality of information terminals of a plurality of users, the distribution time being associated with a time when an event occurs, the question being associated with the event, the plurality of users being involved in the event;
accepting a plurality of responses to the distributed question, from the plurality of information terminals; and
tabulating the plurality of responses on a basis of time differences, each of the time differences being a difference between the distribution time and a time when a corresponding one of the plurality of responses is accepted.
